(19) United States
(12) Patent Application Publication
(10) Pub. No.: US 2022/0378016 A1
(43) Pub. Date: Dec. 1, 2022

(54) COMPOSITE ELECTRICALLY HEATABLE BLANKET FOR DOMESTICATED QUADRUPED ANIMALS

(71) Applicant: Alain Desmeules, Montreal (CA)

(72) Inventors: Alain Desmeules, Montreal (CA); Julie Kassabian, Montreal (CA); Guy Jean Houle, Blainville (CA)

(73) Assignee: Alain Desmeules, Montreal (CA)

(21) Appl. No.: 17/331,740

(22) Filed: May 27, 2021

(51) Int. Cl. A01K 13/00; H05B 3/34

(52) U.S. Cl. CPC A01K 13/008; H05B 3/34

(57) ABSTRACT

A composite horse heating blanket is comprised by an upper electrically heatable blanket section dimensioned and shaped to overlap a top section of a horse's body to cover the back spinal regions and upper regions of the rib cage of the horse on opposite sides of the horse. The upper heating blanket section has a marginal lower side free end edge band region adapted for the securement of a depending blanket section to provide cover below the upper region of the rib cage portion on opposite sides of the horse's body. The upper electrically heatable section is provided with electrical heating elements immovably retained therein at predetermined locations. A battery pouch is provided with dc batteries and a switch controls the electrical power from the batteries to the electrical heating elements. The side blanket sections may be removably attached to the upper blanket section to provide many additional features and advantages with heated or non-heated horse blankets.

### FIELD OF THE INVENTION

The present invention relates to blanketing of domesticated quadruped animals and more particularly, but not exclusively, to a composite electrically heating blanket for horses.

### BACKGROUND OF THE INVENTION

It is known that blanketing horses that live outside during cold climatic conditions is often necessary to keep the horse warm, dry and happy. However, blanketing, if not properly utilized, can lead to problems for the horse, such as bacterial disease caused by the horse sweating and drying under the blanket. It is therefore imperative that horses be managed sensibly during cold winter months to keep the horse comfortable and free from illness cause by adverse weather conditions.

Horses need to maintain body warmth and fed with the proper nutritional needs during winter months. Critical body temperatures for horses is estimated at 41 degrees F., with a summer hair coat, and 18 degrees F., with a winter hair coat. Horses are most comfortable between 18 to 59 degrees F. The cooler the air, the greater the heat loss and wet hair increases heat loss due to the horse's hair reducing its insulation value. It is therefore important that a horse stays dry. A horse standing in the cold often leads to illness and it is therefore important to shelter the horse, such as when expecting sudden cold snaps when the horse has not yet grown a sufficient winter hair coat. Wind and moisture are factors which horses have a difficulty to tolerate. Therefore, it is important to blanket horses that live outside and to constantly monitor the changing weather conditions and more importantly the horses body condition to assure the horses health. Horses that are thin, ill, old or very young are most likely to benefit from blanketing to protect the horses from cold weather and rain. Therefore, the blanket should be waterproof while permitting the escape of moisture from the horse's hair thereunder.

Conventional horse blankets are provided as a barrier to protect a horse from mud, dirt and rain and also provide a certain degree of thermal insulation. Because the blankets are exposed to the elements they become soiled very quickly and require frequent cleaning. A dirty and soiled blanket can affect the health of the horse and infect sores developed under the soiled blanket. Horse blankets also come in different shapes and sizes to conform to horses of different sizes and to assure adequate body coverage. Blankets for horses are also provided in various colors and with specific decorations representative of an owners stable or to suit an event.

Electrically heated blankets have become popular to maintain a horse comfortable during adverse weather conditions or to remove muscle stiffness before and after events or simply before pleasure riding the horse. They can also provide therapeutic heat applications for horses by providing targeted temperature treatments to sore muscles after injuries or muscle strains or to simply warm the horses muscle before physiotherapy or massage therapy. They are also used to relax and warm a jumping or racing horse. These electrically heated blankets usually incorporate electrically heating wires sewn in a pattern between fabric layers or are provided with heating pads and these are derived power from battery supported by the blanket. Reference is made to US Patent Publication 2006/0213156, DE 200 21 260 U1 and DE 41 40 507 A1 as examples of such electrically heated blankets. As can be seen from some of these references, the heating blankets are provided with a great number of heating pads at many different locations, and as such, add excess weight on the hair of the horse and flattens the winter hair coat of the horse which inhibit the insulating ability of the hair coat, making the horse colder than they might have been if not blanketed. Several heating pads also require a larger battery packs adding weight to the blanket.

It would be desirable to provide an electrically heatable blanket for domestic quadruped animals, and particularly, but not exclusively, for horses, and wherein such blanket can incorporate advantages which provide additional benefits to the horse and as well has to the horse owner and assuring and maintaining the good health of the horse.

### SUMMARY OF THE INVENTION

It is therefore a feature of the present invention to provide a composite animal blanket for domesticated quadruped animals and formed by independent inter-connectable parts providing a better quality control of the electrically heatable part of the blanket and facilitating the assembly of the blanket.

Another feature of the present invention is to provide a composite horse blanket formed of an upper electrically heatable blanket section to cover an upper body portion of the horse and which is adapted to permit attachment of opposed dependent blanket sections of different materials to cover a lower body portion of the horse.

A further feature of the present invention is to provide a composite heatable horse blanket and wherein the opposed dependent blanket section are detachably attached to the upper heating blanket section to permit washing and drying of said blanket sections in washing and drying appliances.

Another feature of the present invention is to provide a composite heatable horse blanket and having opposed depending blanket sections which are interchangeable to adapt to different occasions and facilitating the cleaning of these sections when they become soil thus providing additional benefits to the horse's owner.

A still further feature of the present invention is to provide a composite heatable horse blanket incorporating a switch control which permits ease of adjusting the heat intensity of the heating blanket upper section to suit current climatic conditions to which the horse is exposed.

Another feature of the present invention is to provide am smart switch control incorporating a microcontroller wherein the heating blanket upper section can be remotely controlled.

A still further feature of the present invention is to provide a composite heatable horse blanket and wherein opposed depending blanket sections are removably attached to the upper heating section by quick attachment means.

A further feature of the present invention is to provide a composite heatable horse blanket and wherein the upper heatable blanket section can be used as a heatable saddle pad retained under the saddle and further wherein the blanket is provided with a quick-disconnect electrical connector to provide electrical power to external electrical devices associated with a rider person.

A still further feature of the present invention is to provide a composite horse blanket and having an upper blanket section and opposed detachably secured depending blanket sections which are interchangeable to suit different occasions and facilitating the cleaning of these sections in conventional household washing and drying machines when they become soil thus providing additional benefits to the horse's owner and caretaker.

According to the above features, from a broad aspect, the present invention provides a composite animal blanket comprising an upper electrically heatable blanket section which is dimensioned and shaped to overlap an upper section of a domesticated quadruped animal's body. The upper blanket section is shaped to cover the back spinal regions and upper regions of the rib cage of the animal on opposite sides of the back spinal region and terminate with a marginal lower side free end edge region adapted for the securement of a depending blanket section to provide cover below the upper regions of the rib cage portion on opposite sides of the animal body. The upper electrically heatable section has electrical heating elements immovably retained therein at predetermined locations. A battery support is provided for the removable containment of one or more dc batteries. Electrical connections provide electrical power from the one or more dc batteries to the electrical heating elements, and a switch controls the electrical power from the batteries to the heating elements.

According to another broad aspect of the present invention there is provided a composite animal blanket comprised of an upper blanket section dimensioned and shaped to overlap a top section of a domesticated quadruped animal's body to cover the back spinal regions and upper regions of the rib cage of the animal on opposite sides of said back spinal region and terminating with a marginal lower side free end edge region. The marginal side region is provided with detachable attachments for the removable securement of a depending blanket section to provide cover below the upper regions of the rib cage portion on opposite sides of the animal body.

### BRIEF DESCRIPTION OF THE DRAWINGS

A preferred embodiment of the present invention will now be described with reference to the accompanying drawings in which:

FIG. 1 is a side schematic view of a horse fitted with the composite heatable horse blanket of the present invention:

FIG. 2 is a top view showing the disposition of the heating pads relative to the back region of the horse's body;

FIG. 3 is a rear view of an upper part of a horse's body on which the composite heatable horse blanket of the present invention is secured and showing a cross-section view of an example of the construction of the heatable blanket;

FIG. 4 is diagram, partly in block form, showing the control switch and associated circuitry providing control of the heating elements by local or by remote control through a hand operated control device or by a smart control device such as an iPhone communication through the web.

FIG. 5 is a schematic view of an example of removable attachment of the opposed dependent blanket sections to the upper electrically heatable blanket section;

FIG. 8A is a fragmented side view showing an example of the securement of the lower blanket sections to the edge band region of the top heating section of the heatable blanket, and

FIG. 8B is a side view, partly fragmented, illustrating an example of a further detachable attachment assembly of the lower blanket sections to “Velcro” (registered trademark) fasteners behind the edge band region of the top heating blanket section.

### DESCRIPTION OF THE PREFERRED EMBODIMENT

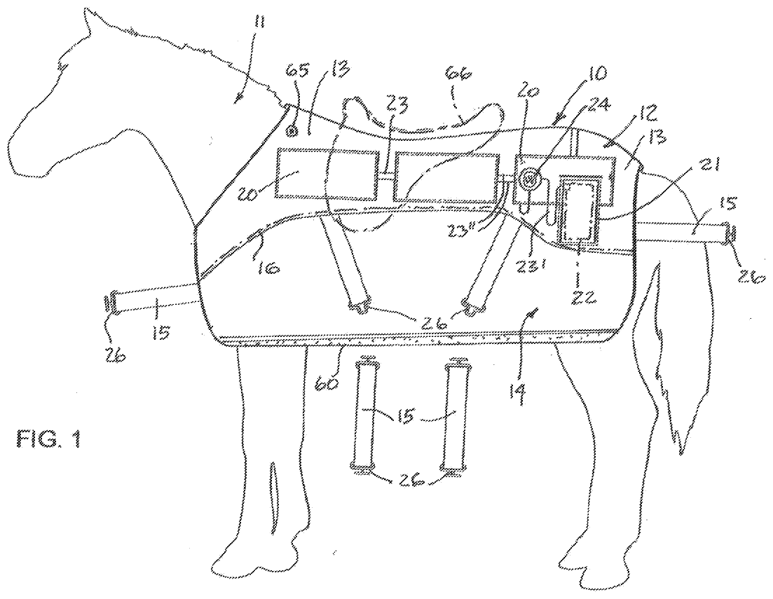

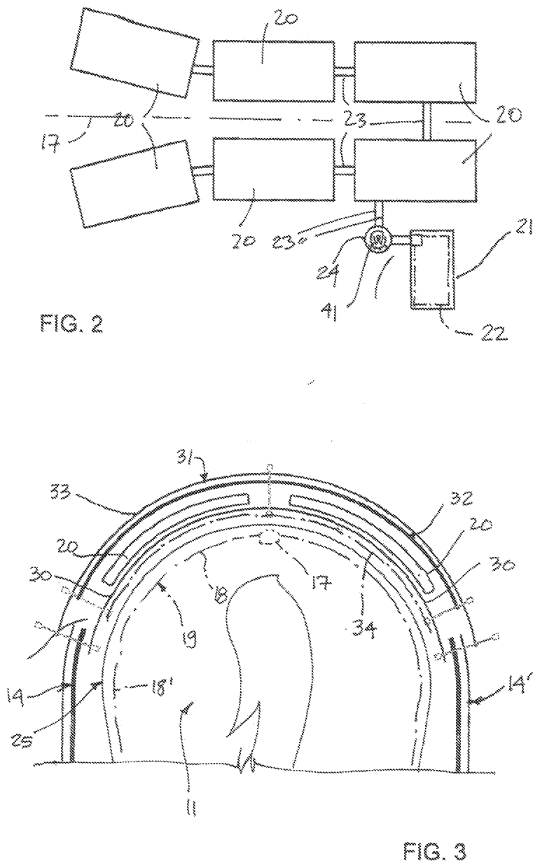

The preferred embodiment of the present invention will now be described with reference to FIGS. 1 to 3 wherein there is shown generally at 10 a horse 11 fitted with the composite heatable blanket 12 of the present invention. The heatable blanket 12 is formed of inter-connectable sections, herein a top heating section 13 to cover the back spinal regions 17 and upper regions 18 of the rib cage 19 of the horse on opposite sides of the back spinal region of the horse and terminating with a marginal lower side free end edge region 25. Lower blanket sections 14 and 14′ are secured to respective ones of the edge band regions 25 and depend therefrom to provide cover to the lower region 18′ of the rib cage 19 on opposite sides of said animal body. The heating blanket 13 is further provided with suitable attachment means to hold the blanket in position of the horse and, herein illustrated in the form of straps 15 which are provided with adjustable strap connectors, herein schematically illustrated at 26, to firmly hold the heating blanket in position on the horse 11. Various other strapping configurations can also be adapted.

As illustrated in FIG. 1, the upper electrically heatable blanket section 13 has electrical heating elements, herein in the form of heating panels 20, immovably retained within the blanket section 13 at predetermined locations. Additional heating pads of different sizes may also be provided at other locations targeting heat to the muscle groups of the horse. A battery support in the form of a pouch 21 is formed integral with the upper electrically heatable section 13 at a convenient location for the removable containment of one or more dc batteries 22, such a lithium ion rechargeable batteries. Electrical wire connections 23 provide electrical power from the one or more dc batteries 22 to the electrical heating panels 20. A switch 24 is electrically connected between the batteries 22 and the heating panels 20 to control the electrical power from the batteries to the electrical heating panels 20, as will be described in more detail below.

Although the drawings illustrates the composite heatable blanket of the present invention as applied to a horse, it is pointed out that such may also be dimensioned to provide heat to other domesticated quadruped animals, such as for example greyhound race dogs, cattle of all sorts, etc. The heatable blanket may also have other uses other than providing comfort to such animals during cold weather conditions, and for example to provide therapeutic benefits to such animals.

As shown in FIG. 3, the composite animal blanket heatable section 13 is constructed of a lining fabric sheet 30 formed of suitable material for contact with the horse's body 25. The blanket further includes an outer fabric composite material sheet 31 sheet with the heating panels 21 immovable retained between the sheets 30 and 31 at predetermined locations, by stitching, glue or other suitable attachment means. The outer fabric composite material sheet 31 is comprised by an inner thin insulating synthetic fiber sheet 32 which is waterproof preventing rain from penetration to the horse's body and breathable to provide humidity to escape from the horse's body. A suitable fiber sheet is one such as “Thinsulate” (Registered Trademark) or similar sheet material, and having a desired weight of about 100 grams per square meter. A thin film thermo-reflective perforated aluminium sheet 33 or other suitable thermo-reflective sheet is secured over said insulating synthetic fiber sheet 32 to reflect heat. Because the heating blanket is formed of independent inter-connectable parts it provides a better quality control advantage in that the upper electrical section is fabricated independently and in different sizes by skilled personnel to prevent errors in the assembly of the positioning and attachment of the electrical wiring and components between the fabric parts, particularly when manufacturing these heating blanket sections of different sizes.

In a further embodiment, shown in FIG. 3 and fragmentally illustrated in FIG. 5, a heat conductive woven textile fabric sheet 34 may be incorporated into the construction of the heatable blanket section 13 and held captive below the heating panels 20 and extending entirely over the lining fabric sheet 30. Such heat conductive textile fabric sheets are well known in the art and are fabricated of woven threads 35 and wherein some of the woven threads are thermally conductive material threads 36. The thermally conductive threads will absorb heat from the electrically heating panels 20 and conduct the absorbed heat throughout the surface area of the heatable blanket section 13 in contact with the horses body 25 to provide a more uniform heat distribution and prevent hot spots on the horse's body directly under the heating panels. In a further embodiment, the heat conductive textile sheet 34 may be formed as a composite textile sheet additionally provided with threads suitable to also form a fleece surface for direct contact with the horses body and such may constitute the lining fabric.

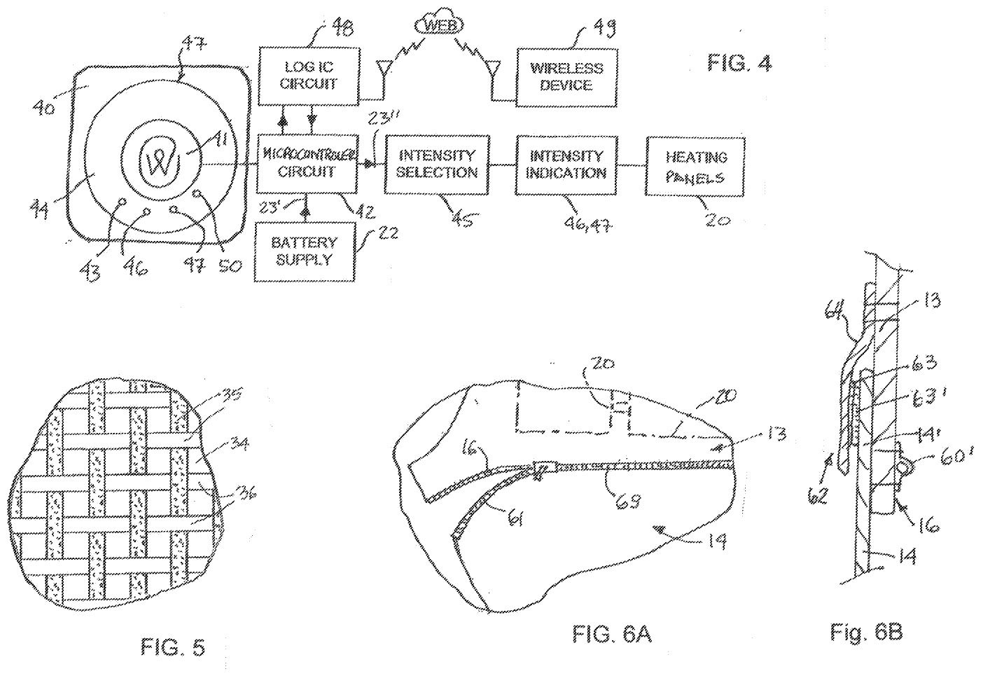

Referring now to FIG. 4, there is illustrated the construction of the switch 24 and its associated electronic circuit incorporated on a pcb (printed circuit board) suitably mounted behind the switch 24. As herein shown, the switch 24 is a push-button switch mounted on a support material patch 40 adapted to be sewn to the heating blanket 13 at a convenient location, herein close to the battery pouch 21 wherein to connect to the power feed conductors 23′ of the batteries 22. The switch 24 has a single push button 41 associated with a multi-function microcontroller circuit 42 and by depressing the switch button once the voltage feed wires 23″ connected the battery supply to the heating wires (not shown, but obvious to a person skilled in the art) provided in the heating panels 20. This causes a selection indicating signal, in the form of a light 43, mounted on a circumferential flange 44 of the push button switch, to light indicating that power is fed to the heating element. As shown, there is a plurality of different lights mounted on the switch push button flange to indicate to the user person a switch selection function that has been engaged. The microcontroller switching circuit 42 has a voltage intensity function circuits 45 which provides an indication of the switch position each time the switch button 41 is depressed to change the voltage intensity to reduce or increase the heat generated by the panels 20. When the switch button is first depressed maximum power is connected to the heating panels 20. Depressing the switch button 41 twice will cause the voltage intensity to drop to a second lower voltage level causing the panels 20 to generate less heat and a second light 46 will provide an indication of this selection. When the switch is toggled again, a further one of the lights, namely light 47 will be lit indicating a further reduction of the heat intensity. Depressing the switch button again will cause all lights to extinguish indicating that the panels are not connected to the batteries. A further light 50 may also be provided to indicate that the batteries are low on power and require charging or to indicate another function from sensors that can be incorporated in the heating blanket to sense other horse functions, such as excess humidity, heart beat, etc. The lower the intensity, the less drain on the battery and the longer usable heating time that can be provided by the batteries. Also, the greater the number of batteries the more power and the longer heating time.

Another envisaged feature of the switching circuit 24 is its incorporation of a logic communication circuit 48 that provides wireless communication via the web with internet conductivity through a router or communication through a WiFi, Bluetooth or other wireless communication networks to a remote wireless device 49 such as an iPhone in possession by a user person or a short range control device operating at RF frequency. This is desirable when the care person does not have easy access to the switch button mounted on the horse to adjust the intensity of the heat generated by the heating blanket 13, and particularly so when the horse is away from the stable outdoors in the coral or when there is a sudden change in climatic conditions occurring, or predicted to momentarily occur, and the care person is at a remote location and not capable of returning to the stable on time to make adjustments to the switch functions.

Referring back to FIGS. 1, 6A and 6B, and to the detachable aspect of the depending blanket sections 14 and 14′, it can be appreciated that this feature of detachment provides several advantages. One important advantage is that the care person can quickly remove any or all of the blanket sections when soiled and immediately replace them with clean and dry depending blanket sections. Because the composite heating blanket is formed of detachable sections, the depending side sections are not overly large, as compared to a full blanket, and thus permitting washing in normal household washing and drying machines as there are no heating components or wires in these blanket sections. Such would avoid expensive dry cleaning costs. This is not possible with standard construction electrical heating blankets which are very large and contain electrical heating wires and components. Therefore, the present invention also relates to standard type, non-electrically heatable, horse blankets but constructed of detachable sections which provide the above described features and advantages.

The marginal lower side free end edge band 16 of the blanket that provides for the detachable feature of the depending blanket sections 14 and 14′, may be provided with several types of fastening means, and as shown in FIG. 6A such means is in the form of a standard apparel zipper 69, a portion of which is secured along the free edge region 16 of the heatable blanket 13 and another mating zipper portion secure to an upper free edge region 61 of the depending side blanket. Other fastening means may comprise magnetic strip couplings which provide quick connect and disconnect and which provide adequate retention force. An example of such magnetic zipper is described in U.S. Pat. No. 10,582,734. Alternatively, the fastening means may be comprised by loop and buttons attachments, or by “Velcro” fasteners, Registered Trademark of the 3M Corporation, as shown in FIG. 6B. As herein illustrated one attachment part 63 of the Velcro fastener 62 is secured to a support fabric strip 64 sewn to the back side 13′ of the top heating section 13 and facing the back side 13′. The other attachment part 63′ is secured to the rear face of the top portion 14′ of the lower blanket section 14 and facing the attachment part 63. By matting the connection parts 63 and 63′ the lower blanket sections are detachably connected behind the lower edge 16 of the heatable top blanket portion 14. The Velcro attachment may be provided as tack attachments formed of Velcro patches secure spaced apart. As herein further illustrated a piping ribbon band 60′, identifying the owner's stable, is sewn along the lower edge of the top heating blanket section.

It is also contemplated that the detachable aspect of the depending blanket sections may provide for the upper heating blanket section 13 to be used solely as a saddle pad on which a saddle can be mounted for a rider person to exercise the horse during winter months or form part of the saddle assembly for use at all time when weather changes suddenly and drastically, such as in Alaska. With such a further use, it would be convenient to provide a quick connector having a plug-in port, as shown at 65 in FIG. 1, secured at a convenient location on the heating blanket in close proximity to the saddle which is represented herein by phantom lines 66. The connector 65 would permit connection of a plug-in connector which can easily disconnect by a pulling force on a power feed wire cable connected thereto. Such plug-in connector would be advantageous to feed power to heated articles of apparel worn by a rider person sitting on the saddle or to portable communication devices carried by the rider person

Another advantage of the composite heatable blanket 10 is its interchangeable feature wherein a care person may simply want to change the depending blanket sections to suit a festive occasion, such as changing the heating blanket to one which suits the Christmas festive season or to a depending blanket section having an owner's identity in the form of a logo, pattern or specific colors, etc. For example, as shown in FIG. 1, the depending blanket sections 14 and 14′ are provided with a decorative band 60 at a lower edge thereof which contains piping of a specific color associated with an owner's stable and which is a desirable feature of horse blankets. The depending blanket sections may also be of a tartan pattern or contain designs identifying certain competition events if the horse is a jumping horse or a racing horse. It is also pointed out that the composite combination with removable blanket sections results in cost savings to a user person wherein a single horse heating blanket section 14 can be easily and quickly configured to represent several different heating blanket designs by simply changing the depending blanket sections 14 to change the overall appearance of the heating blanket. Therefore, several different heating blanket designs can be obtained by simply changing the depending blanket sections while maintaining the heating blanket section which is the most expensive part of the blanket construction. These are some additional features provided by the detachable sectional construction of the horse blanket and wherein the top section may be formed as an electrically heated section or a non-heated section.

It is also contemplated that sensors could be incorporated in the heating blanket section to sense different conditions of the horse, such as sensing humidity or hearth beat and transmit these information signals to the microcontroller which would be programmed to provide the signal information to the care person for monitoring the well being of the horse. The heating blanket sections could also be used as a therapeutic treatment blanket to provide heat to selected muscles of the horse located under the blanket heated section. The blanket could also be provided with a charging port to charge the batteries without removal from its containment in the heating blanket and such could be advantageous to charge the batteries from many locations, such as when being transported in a vehicle, etc. Furthermore, with respect to the interchangeable features of the depending side blanket sections, such may not necessarily be restricted for use with an upper electrically heatable blanket section but with one that is heatable by other means, such as heating pads that are removable inserted in pouches on the heating blanket section. Still further, with respect to the interchangeable features of the depending side blanket sections as mentioned herein above, the upper blanket section need not be a heating blanket section. As such, by providing the blanket in component parts, many advantages as described above can be obtained.

It is therefore within the scope of the present invention to provide a composite animal blanket having an upper heatable blanket section dimensioned and shaped to overlap a top section of a domesticated quadruped animal's body to cover the back spinal regions and upper regions of the rib cage of the animal on opposite sides of the back spinal region. The upper heatable blanket section terminating with a marginal lower side free end edge region which is provided with detachable attachments for the removable securement of a depending blanket section to provide cover below the upper regions of said rib cage portion on opposite sides of said animal body. The upper heatable blanket section has heating elements retained therein at predetermined locations.

It is further within the scope of the present invention to provide a composite animal blanket having an upper blanket section dimensioned and shaped to overlap a top section of a domesticated quadruped animal's body to cover the back spinal regions and upper regions of the rib cage of the animal on opposite sides of the back spinal region. The upper blanket section terminates with a marginal lower side free end edge region which is provided with detachable attachments for the removable securement of a depending blanket section to provide cover below the upper regions of said rib cage portion on opposite sides of the animal body. It is further contemplated that the upper blanket section 13, with or without the heating pads, may also be used as a top cover for the horse when ridding to provide water proofing or warmth to the horse. It may also be used as a decorative cover. Of course, the upper blanket section would be positioned under the saddle pad. Still further, the upper blanket section 13 and the lower blanket sections 14, 14′ may be provided with loop type connectors secured thereto at predetermined positions to permit strapping to be trained there through for securing the blanket sections to the horse. These small connectors would be desirable for the detachable feature of the blanket sections where the sections can be washed and dried in household washing and drying machines. Otherwise, the strapping could be problematic to the washing and drying of the sections. Such small loop connectors are well known in the art and are preferably made of strong plastics material, such as pvc or other industrial grade plastics.

Many modifications and other embodiments of the present invention as described above will come to mind to a person skilled in the art to which the invention pertains having the benefit of the teachings described herein above and the drawings. Hence, it is to be understood that the embodiments of the present invention are not to be limited to the specific examples thereof as described herein and other embodiments are intended to be included within the scope of the present invention and the appended claims. Although the foregoing descriptions and associated drawings describe example embodiments in the context of certain examples of the elements and/or functions, it should be understood that different combinations of elements or substitutes and/or functions may be provided by different embodiments without departing from the scope of the present invention as defined by the appended claims. Furthermore, although specific terms are employed herein, they are used in a generic and descriptive sense only and other equivalent terms are contemplated herein with respect to the items that they relate to. It is therefore within the ambit of the resent invention to encompass all obvious modifications of the examples of the preferred embodiment described herein provide such modifications fall within the scope of the appended claims.

1. A composite animal blanket comprising an upper electrically heatable blanket section dimensioned and shaped to overlap an upper section of a domesticated quadruped animal's body to cover the back spinal regions and upper regions of the rib cage of the animal on opposite sides of said back spinal region and terminating with a marginal lower side free end edge region adapted for the securement of a depending blanket section to provide cover below said upper regions of said rib cage portion on opposite sides of said animal body, said upper electrically heatable section having electrical heating elements immovably retained therein at predetermined locations, a battery support for the removable containment of one or more dc batteries, electrical connections to provide electrical power from said one or more dc batteries to said electrical heating elements, and a switch to control said electrical power from said one or more batteries to said electrical heating elements.

2. The composite animal blanket as claimed in claim 1wherein said domesticated quadruped animal is a horse.

3. The composite animal blanket as claimed in claim 2 wherein said dependent blanket section is detachably attached to said lower side free end edge band region.

4. The composite animal blanket as claimed in claim 3 wherein said detachable fastening means comprises one of zipper fasteners, magnetic coupling strips fasteners, “Velcro” (Registered Trademark) fasteners, loop and button fasteners, and other detachable fastening means permitting attachment and detachment.

5. The composite animal blanket as claimed in claim 2 wherein said upper electrically heatable section is comprised of a lining fabric sheet adapted for contact with said horse body, an outer fabric material sheet, and a plurality of heating panels constituting said electrically heated elements secured at said predetermined positions and immovably retained between said outer fabric material and said lining fabric sheet.

6. The composite animal blanket as claimed in claim 5 wherein there is further provided a heat conductive woven textile fabric sheet held captive under said plurality of heating panels, said heat conductive textile fabric being fabricated of woven threads and wherein some of said woven threads are thermally conductive fiber threads for absorbing heat from said electrically heated panels and conducting said absorbed heat throughout said upper electrically heatable blanket section to distribute heat to the horses body thereunder.

7. The composite animal blanket as claimed in claim 6 wherein said heat conductive woven textile fabric sheet also constitutes said lining fabric material sheet.

8. The composite animal blanket as claimed in claim 5 wherein said outer fabric material is comprised by an inner thin insulating synthetic fiber sheet which is waterproof and breathable, such as “Thinsulate” (Registered Trademark) or similar sheet materials.

9. The composite animal blanket as claimed in claim 8 wherein said outer synthetic fiber sheet has a weight of about 100 grams per square meter, and further wherein a thin film thermo-reflective textile sheet is secured over said insulating synthetic fiber sheet to reflect heat.

10. The composite animal blanket as claimed in claim 9 wherein said thermo-reflective textile sheet is a thin sheet containing fiber threads of reflective metal, such as aluminium.

11. The composite animal blanket as claimed in claim 1 wherein said switch is a multi-function press-button switch assembly including a printed circuit board on which is mounted electronic circuits and secured to a support material patch attached to said heatable blanket in close proximity to said battery support, said press-button switch providing signals to a microcontroller to perform functions selected by depressions of said press-button switch, and display means to display the actual selected switch function.

12. The composite animal blanket as claimed in claim 11 wherein said switch functions are comprised of a switch depression to cause said switch to connect electrical power from said one or more batteries to said electrically conductive heating elements, another switch depression to disconnect said electrical power from said electrically conductive heating elements, and further switch depression for selecting different intensities power connected to said electrically conductive heating elements by predetermined incremental power values.

13. The composite animal blanket as claimed in claim 12 wherein said display means is provided by a plurality of light modules secured to said support material patch and providing an indication of a selected switch function.

14. The composite animal blanket as claimed in claim 11 wherein said electronic circuit microcontroller is further provided with communication components for communication with a remote wireless control device for operation of said switch functions.

15. The composite animal blanket as claimed in claim 14 wherein said remote wireless control device is one of a close-proximity wireless control mobile device suitable for remote control through a WiFi wireless network or a smart wireless control mobile device interfaced with internet conductivity through a router.

16. The composite animal blanket as claimed in claim 13 wherein said dependent blanket sections contain decorative and/or customized identifications representative of a particular stable and/or event, such as a show jumping competition.

17. The composite animal blanket as claimed in claim 1 wherein said upper electrically heatable blanket section and/or said depending blanket sections are provided with detachable attachment for securing said composite animal blanket to said body of said domesticated quadruped animal.

18. The composite animal blanket as claimed in claim 2 wherein said upper electrically heatable blanket section is dimensioned and shaped for use as a saddle pad without said dependent blanket sections secured to said lower side free end edge.

19. The composite animal blanket as claimed in claim 18 wherein there is further provided a plug-in power outlet connector secured to said upper electrically heatable blanket section and to said one or more batteries to provide power to other electrically powered articles associated with a rider person sitting on a saddle secured over said saddle pad, and a feed wire provided with a quick-disconnect connector secured in said plug-in outlet to provide power to said other electrically powered articles and to permit disconnection of said quick-disconnect connector by a pulling force acting on said feed wire.

20. A composite animal blanket comprising an upper blanket section dimensioned and shaped to overlap a top section of a domesticated quadruped animal's body to cover the back spinal regions and upper regions of the rib cage of the animal on opposite sides of said back spinal region and terminating with a marginal lower side free end edge region, each said marginal side region being provided with detachable attachments for the removable securement of a depending blanket section to provide cover below said upper regions of said rib cage portion on opposite sides of said animal body.
